(19) United States
(12) Patent Application Publication
(10) Pub. No.: US 2017/0353541 A1
(43) Pub. Date: Dec. 7, 2017

(54) NON-TRANSITORY RECORDING MEDIUM, INFORMATION PROCESSING METHOD, MANAGEMENT NODE AND INFORMATION PROCESSING SYSTEM

(71) Applicant: FUJITSU LIMITED, Kawasaki-shi (JP)

(72) Inventor: Isao Higashi, Yokohama (JP)

(73) Assignee: FUJITSU LIMITED, Kawasaki-shi (JP)

(21) Appl. No.: 15/604,846

(22) Filed: May 25, 2017

(30) Foreign Application Priority Data
Jun. 6, 2016 (JP) 2016-112920

(51) Int. Cl. H04L 29/08

(52) U.S. Cl. CPC H04L 67/1008

(57) ABSTRACT

The computer system monitors a load of a first process. The computer system transfers a processing program to execute a second process related to the first process to a processing node to be scaled out for executing the second process via a network when the load of the first process fulfills a first condition.

### CROSS-REFERENCE TO RELATED APPLICATIONS

This application is based upon and claims the benefit of priority of the prior Japanese Patent Application No. JP2016-112920, filed on Jun. 6, 2016, the entire contents of which are incorporated herein by reference.

### FIELD

The present invention is related to non-transitory recording medium, information processing method, management node and information processing system.

### BACKGROUND

Over the recent years, such a scheme has been adopted as to build up a system by applying a container technology to microservices. The microservices can be said to be a development technique for creating one application by linking a plurality of services that is lighter in weight than an entire system to be built up. According to the microservices, the services that had hitherto been built up as one system are separated into the services per duty. The separated services per duty are linked by a simple and loose linkage instanced by RESTful, whereby the application is built up by combining the individual separated services. Portability and availability of the system can be enhanced by being thus separated into the services per duty and linked by the simple and loos linkage. Note that the RESTful is a software architecture exemplified by a Web, which is called Representational State Transfer (REST).

As described above, the container technology is utilized for adopting building-up of a microservice-based system as the case may be. The container can be said to be a technology for creating a plurality of separated spaces in a single Operating System (OS) and providing a different application environment per separated space. It can be also said that the container is capable of providing a different OS environment by separating Processes in an environment of a single OS kernel.

A virtual machine has hitherto been adopted as a technology of providing the different OS environment. In the virtual machine, e.g., virtualization software instanced by Hypervisor provides virtual hardware to operate a guest OS. The gust OS of the virtual machine operates in the same way as an OS on a physical machine does.

On the other hand, in a container environment, a plurality of containers operates as the Processes on the single OS kernel, and hence a usage quantity of hardware resources, an overhead and other equivalent items become smaller than the virtual machine. It can be therefore expected that the building-up of the microservice-based system and a system operation are made efficient by utilizing a lighter container technology than the virtual machine.

By the way, a scale-out is implemented in order to improve performance of the built-up system in some cases. FIG. 1 illustrates an information processing system including a plurality of services to be scaled out individually. In FIG. 1, the information processing system is built up by user interfaces (UIs) and microservices instanced by account management, creation of documents, graph rendering, an approval process, data registration, and generation of graphical data. Note that the account management is to make use of processing results of the respective microservices instanced by the creation of the documents, the approval process and the data registration. The graph rendering is to make use of the processing result of the microservice, i.e., the generation of the graphical data. Note that the respective microservices in FIG. 1 can be respectively implemented by employing the container technology described above.

FIG. 2 illustrates comparisons among a physical environment, a virtual machine based virtual environment, and a container based virtual environment. In the physical environment, the information processing system includes, e.g., hardware, an OS, middleware and an application. In the virtual machine based virtual environment, the information processing system includes, e.g., the hardware, a host OS, Hypervisor, one or more guest OSs, the middleware on the guest OSs, and the applications on the middleware. On the other hand, in the container based virtual environment, the information processing system includes the hardware, the OS, and one or more containers on the OS. Each container includes the middleware, and the application on the middleware. As described above, the containers are started up as different Processes on one OS kernel.

The following is what features of the container technology against the virtual machine are exemplified. The container is faster in startup than the virtual machine. This is because the startup of the container corresponds to a startup of the Process on the OS. The container environment is smaller in usage quantity of a memory than the virtual machine environment. This is because the container environment has the OS or the OS kernel as a common element, and one or more containers themselves on the OS include none of the kernel. Note that the kernel of the OS is commonized in the container technology, and the Process separated per container enables the startup of a software component (also called the middleware) other than the kernel. In the container environment, the OS downloads a container image already registered in a repository, and a container type virtual environment can be started up as one Process of the OS based on the downloaded container image by utilizing a container management tool exemplified by “Docker”.

Accordingly, e.g., in the information system illustrated in FIG. 1, a scale-out can be done for each individual microservice by using the container technology. For example, such a scheme is practicable that corresponding to a load of the individual microservice, three nodes are allocated to the UI; the two nodes are allocated to the account management; the two nodes are allocated to the data registration; and the two nodes are allocated to the generation of the graphical data. It is to be noted that the scale-out is one of techniques for improving performance of a computer system enabled to change a number of processing nodes to execute a plurality of processes by distributing loads. The scale-out can be said to be an addition of the processing nodes allocated to the processes that are executed in the computer system.

### DOCUMENTS OF PRIOR ARTS

### Patent Documents

[Patent Document 1] Japanese Patent Application Laid-Open Publication No. 2012-99062
[Patent Document 2] Japanese Patent Application Laid-Open Publication No. 2007-148469
[Patent Document 3] Japanese Patent Application Laid-Open Publication No. 2015-153402

### SUMMARY

An aspect of an embodiment is illustrated by a computer readable non-transitory recording medium storing a computer program to make a computer system enabled to change a number of processing nodes to execute a plurality of processes by distributing loads. The computer program configured to make the computer system execute monitoring a load of a first process. And the computer system transfers a processing program to execute a second process related to the first process to a processing node to be scaled out for executing the second process via a network when the load of the first process fulfills a first condition.

The object and advantage of the embodiment will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a diagram illustrating an information processing system including a plurality of services that are individually scaled out;

FIG. 2 is a diagram illustrating comparisons among a physical environment, a virtual machine based virtual environment, and a container based virtual environment;

FIG. 3 is a diagram illustrating a container startup process in an information system adopting a container technology;

FIG. 4 is a diagram illustrating an example of implementing a scale-out in an information processing system according to a comparative example 1;

FIG. 5 is a diagram illustrating details of the scale-outs among services having dependencies;

FIG. 6 is a diagram illustrating a variation in status of the service;

FIG. 7 is a diagram illustrating the details of the scale-outs among the services having the dependencies in the information processing system according to an embodiment 1;

FIG. 8 is a diagram illustrating a comparison between a procedure of the scale-out in the comparative example 1 and a procedure of the scale-out in the embodiment 1;

FIG. 9 is a flowchart illustrating a processing procedure of the scale-out implemented in the information processing system in the embodiment 1;

FIG. 10 is a diagram illustrating processes of the scale-out in a comparative example 2;

FIG. 11 is a diagram illustrating dependencies among microservices;

FIG. 12 is a time chart illustrating processes in a comparative example 3;

FIG. 13 is a diagram illustrating a processing example when the information processing system previously downloads a container image according to the comparative example 3;

FIG. 14 is a diagram illustrating a configuration of the information processing system;

FIG. 15 is a diagram illustrating a hardware configuration of an information processing apparatus;

FIG. 16 is a flowchart illustrating processes of a container cluster management program;

FIG. 17 is a flowchart illustrating processes of a container management program;

FIG. 18 is a diagram illustrating a structure of a service status table;

FIG. 19 is a diagram illustrating a structure of a service dependence table;

FIG. 20 is a diagram illustrating status transitions of the services.

### DESCRIPTION OF EMBODIMENT(S)

Efficient building-up of a system and an efficient operation of the system may be expected in the information processing system built up by a container technology and microservices. For example, according to the microservices, the system may be made sound with a small addition of resources by implementing the scale-out for each of the services separated per duty. On the other hand, according to the microservices, one application is generated by linking the plurality of services with each other. Accordingly, when increasing a number of equipments corresponding to a load of one service, there rises the number of the equipments corresponding to a load of another service in linkage with this one service as the case may be. In other words, the scale-out of one service leads to the rise in load of another service in a chained manner, with the result that another service is scaled out.

Note that it does not mean that the chained rise in load is limited to the container technology. For instance, the same occurs when building up the system based on the microservices by using the virtual machine. Specifically, a number of the virtual machines increases corresponding to the load of the virtual machine implementing one service, in which case this increase leads to a rise in number of other virtual machines implementing other services in linkage with this one service.

In other words, to take the container technology for one example, one process may possibly be related to other processes in terms of processing on the computer. For example, a result of one process can become an input of another process in some cases. Therefore, when a throughput is improved as a result of being scaled out due to the increase in load of one process, there is a possibility that the load of another process rises due to an increase in processing request for another process. Further, when the throughput is improved as the result of being scaled out due to the increase in load of one process, there is also a possibility that the load of another process rises due to an increase in input to another process.

Thus, when system contains a plurality of processes with one process being related to another process, a determination as to whether the scale-out is required with respect to every process probably entails a considerable length of time till normalizing the loads of the whole system. On the other hand, when the scale-out is implemented for one process, the scale-out is simply implemented in another process having the relationship described above, in which case it is not definite whether such a state occurs that the scale-out is actually implemented in another process having the foregoing relationship, and there is a possibility of implementing the scale-out with futility.

According to a computer program illustrated in this embodiment, it is feasible to increase the number of the processing nodes to execute the processes rapidly while restraining the futility in the computer system including the processing nodes to execute the plurality of processes related to each other by distributing the loads.

An information processing system according to one embodiment will hereinafter be described with reference to drawings. A configuration of the following embodiment is an exemplification, and the present information processing system is not limited to the configuration of the embodiment.

### Comparative Example 1

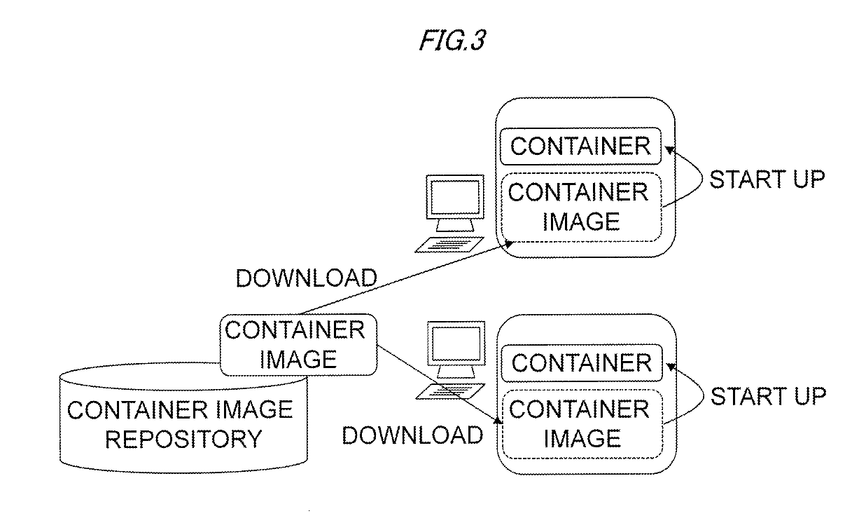

FIGS. 3 through 5 illustrate the information processing system according to a comparative example 1. FIG. 3 illustrates a container startup process in the information processing system that adopts a container technology. The information processing system depicted in FIG. 3 includes a container image repository for registering containers, and nodes connected to the container image repository via a network. The container image repository and the nodes are apparatuses, equipments and other equivalent devices, which are called information processing apparatuses, servers or computers, respectively.

A container image is registered in the container image repository of the information processing system in FIG. 3. A management tool (e.g., “Docker”) manages implementation of the container in the information processing system in FIG. 3. When the container is allocated to one node, the container is downloaded into the node allocated with the container from the container image repository, thus starting up the container. A container image contains middleware encompassing application programs and software components other than an OS kernel.

The container image is herein defined as a program including the middleware serving as interfaces with the OS kernel, and applications. The OS kernel starts up the container as one Process on the OS kernel by way of the container image. Each container provides a virtual environment as one Process on the OS kernel.

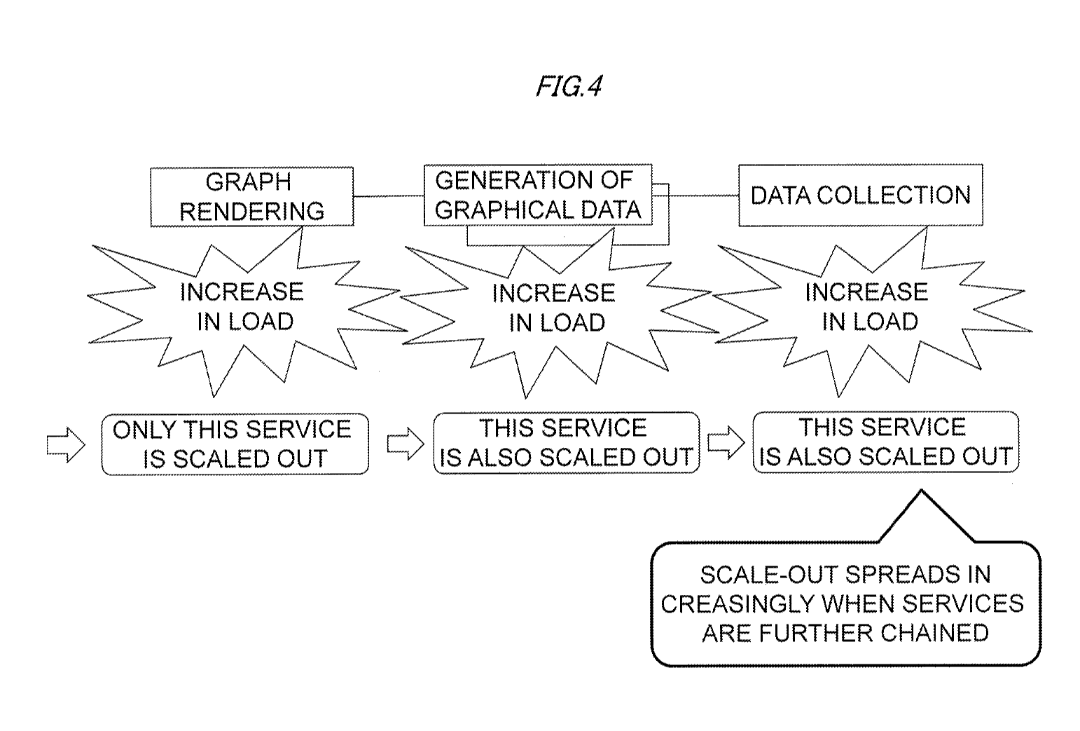

FIG. 4 illustrates an example of how a scale-out is implemented in the information processing system according to the comparative example 1. The comparative example 1 assumes a case of running the application by linking three microservices instanced by rendering a graph, generating graphical data and collecting data in the information processing system. A graph rendering process receives a result of a graphical data generation process, and the graphical data generation process receives a result of a data collection process.

It is now assumed that the service of executing the graph rendering process is scaled out due to an increase in load of the graph rendering process. It is then supposed that a load of the graphical data generation process of providing the data to the graph rendering process rises concomitantly with an improvement of performance of the graph rendering process. Consequently, the service of executing the graphical data generation process is scaled out. It is further supposed that a load of the data collection process of providing the data to the graphical data generation process rises concomitantly with the improvement of performance of the graphical data generation process. Resultantly, the service of executing the data collection process is further scaled out. A chain of scale-outs thus spreads among the services in linkage with each other. As in FIG. 4, a plurality of services in linkage with each other, which has such a relationship that a processing result of one service is utilized by the next service, is called the plurality of services having dependencies on each other.

Note that FIG. 4 illustrates the chain of scale-outs when one service is scaled out ahead in the dependency between one service and another service of providing the data to this one service. The chain of scale-outs, however, may also occur backward. To be specific, another service of providing the data to one service is scaled out ahead, and this one service provided with the data is resultantly scaled out, whereby the chain of scale-outs may also spread among the services in linkage with each other.

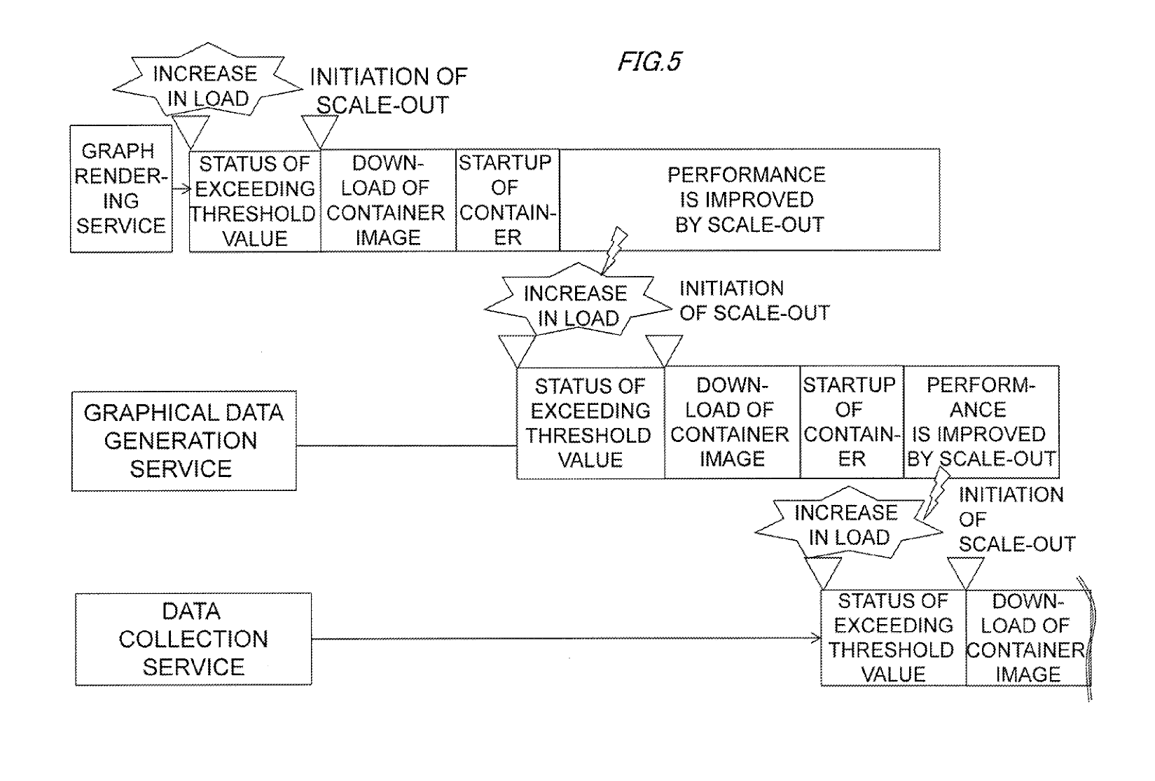

FIG. 5 depicts details of the scale-outs among the services having the dependencies. As explained in FIG. 4, at first, the assumption is that the service of executing the graph rendering process increases in load. When the load exceeds a predetermined threshold value, the scale-out is initiated. The information processing system according to the comparative example 1 uses the container technology. The scale-out therefore involves allocating a new node to the container corresponding to the graph rendering process, and downloading the container image into the allocated node from the container image repository. The downloaded container image is started up after being downloaded. The scale-out is attained by starting up the container corresponding to the graph rendering process on the newly allocated node, thereby improving the performance of the service of executing the graph rendering process.

When a throughput increases with the improvement of the performance of the service of executing the graph rendering process, there rises the load of the service of the graphical data generation process of providing rendering data to the service of the graph rendering process. When the load of the service of the graphical data generation process reaches the predetermined threshold value, a new node is allocated also to the service of the graphical data generation process, thereby implementing the scale-out. Specifically, the new node is allocated to the service of the graphical data generation process, and the container image is downloaded and then started up. The same scale-out is implemented also for the service of the data collecting process.

As in FIGS. 4 and 5, the dependencies exist among the services, in which case one service is burdened with a high load and is thereby scaled out with the result that the loads of the related services increase in a chained manner, and the scale-out is further implemented. A rate of download time occupying till the scale-out is completed rises in the processes of FIG. 5.

### Embodiment 1

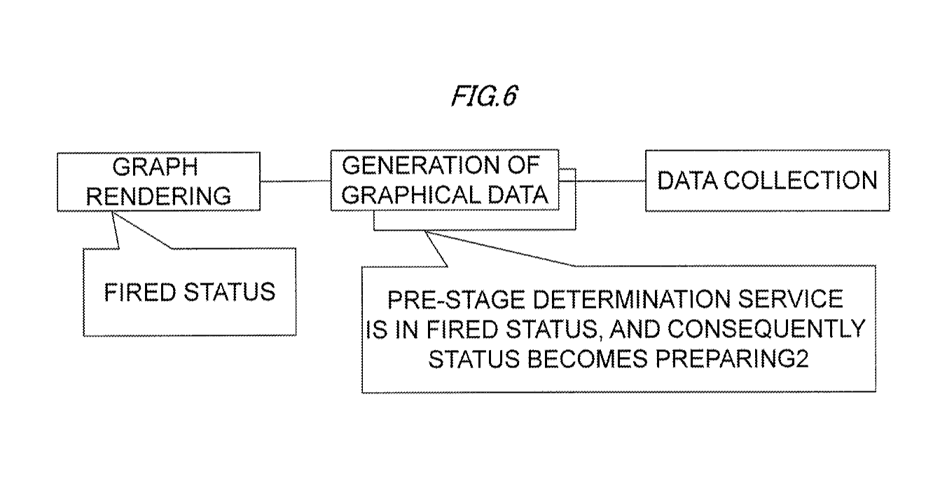

An information processing system 100 according to an embodiment 1 will be exemplified with reference to FIGS. 6 through 9. The embodiment 1 is contrived to improve efficiency of the scale-out in the information processing system 100 with the loads increasing in the chained manner as in the comparative example 1 described above. The information processing system 100 therefore interprets the dependencies among the services, and defines a new status for each service to implement the scale-out efficiently.

The dependencies among the services in the embodiment 1 are the same as those described in the comparative example 1. To be specific, as in FIG. 4, a relationship between one service and another service of providing the data to this one process is termed the dependency. The chain of scale-outs occurs such that one service is scaled out ahead, and another service of providing the data to this one process is next scaled out. In this case, the service, which is scaled out ahead, is to be termed a pre-stage determination service.

The chain of scale-outs can also occur backward. Specifically, another service of providing the data to one process is scaled out ahead, and this one service provided with the data is resultantly scaled out, whereby the chain of scale-outs can also spread among the services in linkage with each other. In this case also, the service, which is scaled out ahead, is to be termed the pre-stage determination service.

The following are the respective statuses.

Status 1: A status 1 corresponds to a case in which the load is within the threshold value. The status 1 is called a stable status.
Status 2: A status 2 corresponds to a case in which the load exceeds the threshold value, and a period of time, for which the load continues exceeding the threshold value, is within a predetermined period of time. The status 2 is called a status of preparing 1.
Status 3: A status 3 corresponds to a case in which the load exceeds the threshold value, and the load continues exceeding the threshold value for a predetermined period of elapsed time. The status 3 is called a fired status.
Status 4: A status 4 corresponds to a case in which the pre-stage determination service is in the fired status, and the load of this service is within the threshold value. The status 4 is called a status of preparing 2.
Status 5: A status 5 corresponds to a case in which the this service is in the status of preparing 2, and the load of this service exceeds the threshold value. The status 5 is also called the fired status.

The information processing system 100 according to the embodiment 1 performs the following actions with respect to the respective statuses.

Action 1: In the case of such a high-load status (fired status) that the load of the pre-stage determination service continues exceeding the threshold value for the predetermined period of time, the scale-out is implemented just when the load of self-service exceeds the threshold value (status 5). To be specific, the information processing system 100 implements the scale-out when the service reaches the status 5. In this case, the information processing system 100 does not check whether the load of the self-service exceeds the threshold value continuously for the predetermined period of time.

Action 2: The information processing system 100 prepares the scale-out in the status 2 (preparing 1) and the status 4 (preparing 2). Specifically, the information processing system 100 allocates the node to the service, and downloads the container image into the allocated node. Such a possibility also exists that, for example, the self-service does not resultantly rise in load and is not therefore scaled out in the action 2, resulting in futility of the download. However, the information processing system 100 performs the action 2 by determining that the scale-out is high in occurrence probability. When the self-service becomes the status 3 or status 5, the downloaded container image is actually started up as a result of making the preparation in the action 2.

Similarly to the comparative example 1 described above, FIG. 6 depicts status variations of the three dependent services, i.e., the service of the graph rendering process, the service of the graphical data generation process and the service of the data collection process. In FIG. 6, the status, in which the load of the service of the graph rendering process already exceeds the threshold value, continues for the predetermined period of time and becomes the status 3 (fired status). In this case, the service of the graphical data generation process dependent on the service (non-dependent service) of the graph rendering process comes to the status 4 (the status of preparing 2). In other words, the service of the graph rendering process is already scaled out, and the service of the graphical data generation process is prepared.

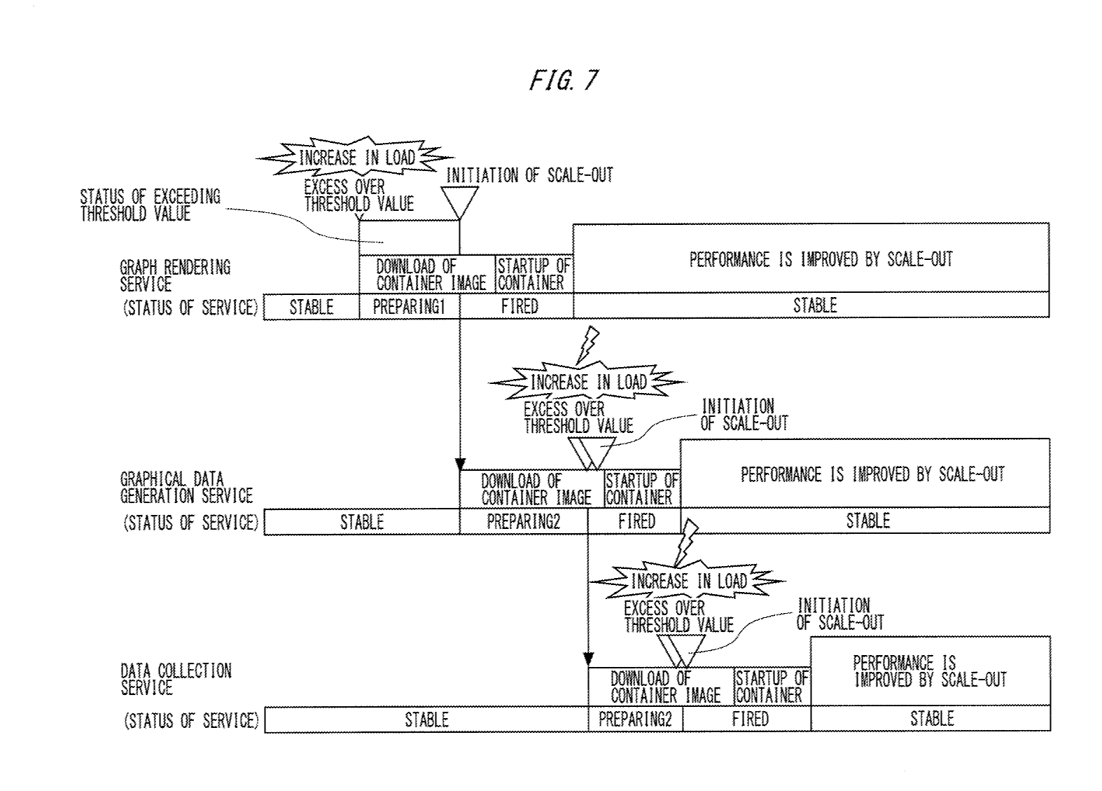

FIG. 7 illustrates details of the scale-outs among the services having the dependencies in the information processing system 100. In the embodiment 1 also, the information processing system 100 uses the container technology. For example, the information processing system 100 includes the plurality of nodes, and allocates the respective nodes to the plurality of services having the dependencies. Each of the nodes allocated to the individual services starts up the container corresponding to the service allocated with this node. The information processing system 100 is one example of “a computer system enabled to change a number of processing nodes to execute a plurality of processes by distributing loads”.

To start with, an assumption is that the service of executing the graph rendering process kept so far in the status 1 (the stable status) has an increased load. When the load exceeds the predetermined threshold value, the service becomes the status 2 (the status of preparing 1). The service of the graph rendering process is, upon becoming the status 2 (the status of preparing 1), newly allocated with the node that implements the service. The container image of the service of the graph rendering process is downloaded into the newly allocated node. In other words, the preparation for the scale-out is initiated for the service of the graph rendering process.

When the status 2 (the status of preparing 1) continues for the predetermined period of time, the service becomes the status 3 (the fired status), thereby initiating the scale-out. Specifically, the container is started up by the downloaded container image on the node newly allocated to the service. The container is started up on the newly allocated node, whereby the service of the graph rendering process decreases in load and becomes the status 1 (the stable status).

When the service of executing the graph rendering process further becomes the status 3 (the fired status), a management apparatus of the information processing system 100 is notified that the service of the graph rendering process is in the status 3 (the fired status). As a result, the service of the graphical data generation process of providing the data to the service of the graph rendering process becomes the status 4 (the status of preparing 2). For example, a master server 2 and a container image repository server 1 in an embodiment 2 are applicable to the management apparatus of the information processing system 100.

The service of the graphical data generation process is, upon becoming the status 4 (status of preparing 2), newly allocated with the node that implements the service. The container image of the service of the graphical data generation process is downloaded into the newly allocated node.

When the load of the service of the graphical data generation process exceeds the predetermined threshold value, the status comes to the status 5 (the fired status), thereby initiating the scale-out. To be specific, the container is started up by the downloaded container image on the node newly allocated to the service. With the startup of the container on the newly allocated node, the load of the service of the graphical data generation process decreases, resulting in becoming the status 1 (stable).

When the service of the graphical data generation process comes to the status 5 (the fired status), the management apparatus of the information processing system 100 is notified that the service of the graphical data generation process is in the status 5 (the fired status). As a result, the service of the data collection process of providing the data to the service of the graphical data generation process, becomes the status 4 (the status of preparing 2).

The service of the data collection process is, upon becoming the status 4 (the status of preparing 2), allocated with the node that implements the service. The container image of the service of the data collection process is downloaded into the allocated node.

When the load of the service of the data collection process exceeds the predetermined threshold value, the status becomes the status 5 (the fired status), whereby the scale-out is initiated. Specifically, the container is started up by the downloaded container image on the node newly allocated to the service. With the startup of the container on the newly allocated node, the load of the service of the data collection process decreases, resulting in becoming the status 1 (stable).

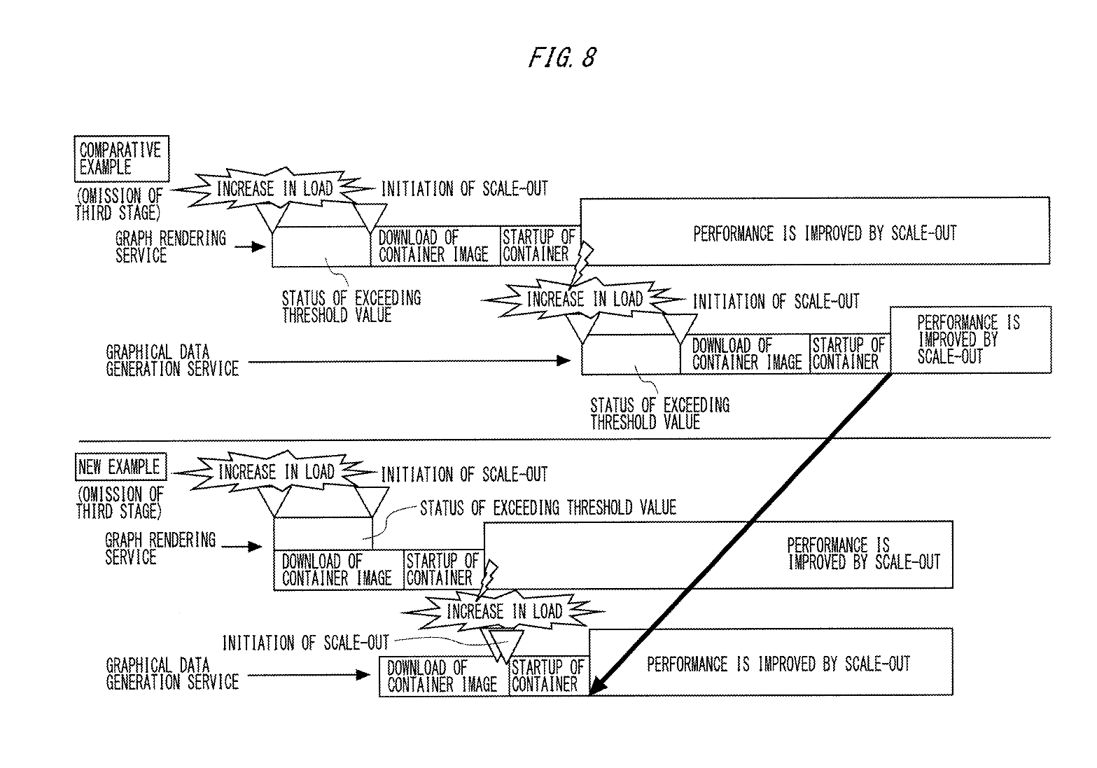

FIG. 8 is a diagram for comparing a scale-out procedure in the comparative example 1 (FIG. 5) with a scale-out procedure in the embodiment 1. A flow on an upper side in FIG. 8 indicates a processing procedure in the comparative example 1 illustrated in FIG. 5. While on a lower side in FIG. 8, a flow indicates a processing procedure in the embodiment 1 illustrated in FIG. 7. As on the lower side in FIG. 8, according to the embodiment 1, when one service is scaled out, another service related to this one service initiates the preparation for being scaled-out. To be specific, the service of the graph rendering process supplied with the data from the service of the graphical data generation process initiates being scaled out, and simultaneously the service of the graphical data generation process of providing the data to the service of the graph rendering process initiates the preparation for being scaled out. In other words, the container image of the graphical data generation process is downloaded into the node allocated to the service. Accordingly, the load of the graphical data generation process exceeds the predetermined threshold value, in which case the container image has already been downloaded, and the node is thereby enabled to immediately start up the container from the container image.

The procedure in the embodiment 1 accelerates completion of the scale-out faster by a length of time indicated by an arrow in FIG. 8 than the procedure for performing the scale-out when exceeding the threshold value in such a way that the information processing system 100 monitors individually the loads of the respective services as in the comparative example 1. Note that though FIG. 8 illustrates the scale-outs when the dependency exists between the two services, an effect in reducing the scale-out time according to the embodiment 1 gets greater with a larger number of services having the dependencies and being linked sequentially.

It is to be noted that the service initiates being scaled out ahead in FIG. 8 is referred to as the pre-stage determination service, and the service initiating the preparation for being scaled out when the pre-stage determination service is scaled out is termed a service concerned. In FIG. 8, the service of the graph rendering process provided with the data from the service of the graphical data generation process is the pre-stage determination service, and the service of the graphical data generation process of providing the data to the service of the graph rendering process is the service concerned. However, the sequence of the chain of scale-outs is reversed to that in FIG. 8 as the case may be. Concretely, the service of the graphical data generation process of providing the data to the service of the graph rendering process can be scaled out ahead as the pre-stage determination service. In this case, it may be sufficient that when the service of the graphical data generation process as the pre-stage determination service is scaled out, the service of the graph rendering process as the service concerned prepares for being scaled out, namely, this service is configured to download the container image.

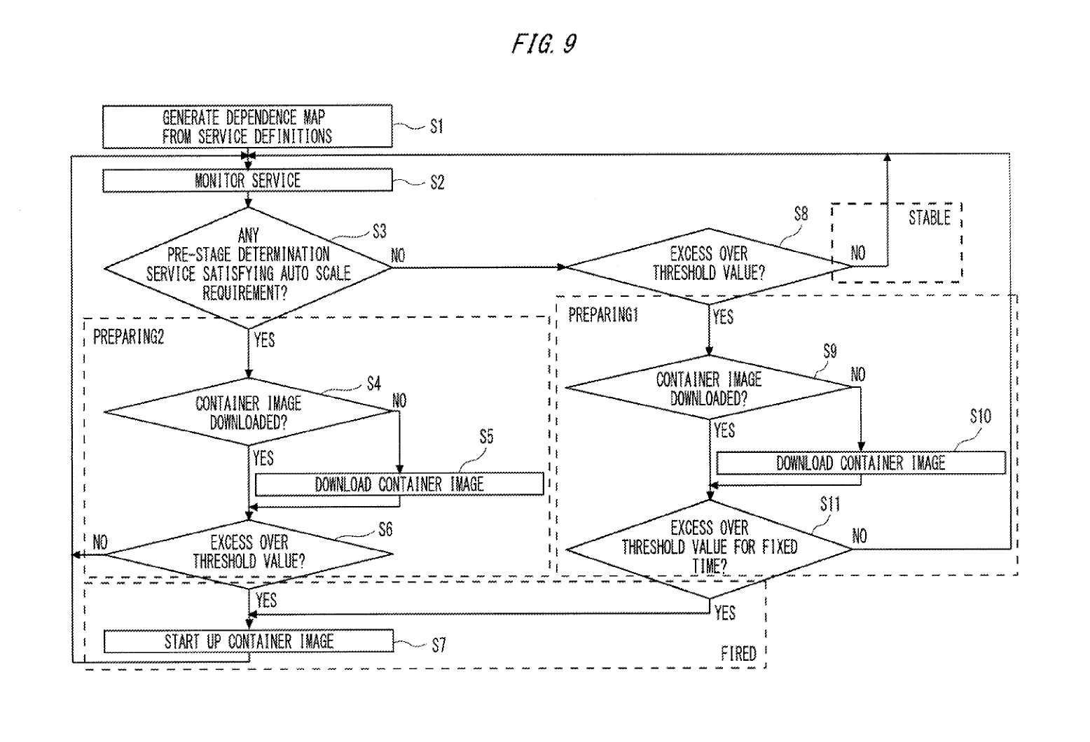

FIG. 9 illustrates the processing procedure of the scale-out to be implemented in the information processing system 100. FIG. 9 is a flowchart illustrating processes in terms of focusing on one service (which will hereinafter be called the service concerned). To begin with, the information processing system 100 according to the embodiment 1 creates a dependence map from service definitions (S1). The service definitions are, e.g., input information to the services, output information from the services, and information of defining the processes for acquiring the output information from the input information. The service definitions are set by, e.g., a user.

In the embodiment 1, a service of an acquiring destination from which to acquire the input information to the service concerned, is called a dependent service. A service of a providing destination to which the service concerned provides the output information, is called a dependentee service (a service receiving the dependence). The information processing system 100 generates a dependence map representing dependencies among the services, based on items of information about the acquiring destination of the input information and the providing destination of the output information.

The dependence map has definitions of relationships between the respective services and the dependent services. Note that the dependentee services with respect to the respective services may be grasped by tracing the dependence map backward as far as the dependent services with respect to the services can be defined. The dependence map may, however, be structured to define both of the dependent services and the dependentee services with respect to the respective services. A table storing the dependence map is called a dependence table. For example, FIG. 19 in an embodiment 2 will illustrate the dependence table.

In the embodiment 1, when the dependentee service i.e., the service of the providing destination of the output information of the service concerned satisfies a scale-out requirement, the service concerned becomes the status 4 (the status of preparing 2). In this context, according to the embodiment 1, the dependentee service is to be called the pre-stage determination service. The pre-stage determination service is one example of “a first process”. The service concerned with respect to the pre-stage determination service is one example of “a second process”.

Note that it is one example of the process to set the dependentee service as the pre-stage determination service, but it does not mean that the information processing system 100 is limited to the process such as this. For example, the dependent service, namely, the service becoming the acquiring destination of the input information of the service concerned may also be set as the pre-stage determination service. In other words, when the service becoming the acquiring destination of the input information is scaled out, the service concerned may also be configured to become the status 4 (the status of preparing 2).

Next, the information processing system 100 monitors the services (S2). The information processing system 100 determines whether there exists any pre-stage determination service satisfying the scale-out requirement (S3). The processes in S2 and S3 are one example of “monitoring a load of the first process”. A determination (Yes determination in S3) that there exists the pre-stage determination service satisfying the scale-out requirement, is one example that “the load of the first process fulfills a first condition”.

Note that the scale-out requirement is a requirement for automatically determining whether the scale-out is implemented, and is therefore called an auto scale requirement as well. When there exists the pre-stage determination service satisfying the scale-out requirement, the information processing system 100 determines whether the container image is downloaded (S4). When the container image is not downloaded, the information processing system 100 downloads the container image from the container image repository (S5). A downloading destination is a node on which the downloaded container image is to be started up. The process in S5 is one example of “transferring a processing program to execute a second process related to the first process to a processing node to be scaled out for executing the second process via a network”.

The information processing system 100 determines whether the load of the service concerned exceeds the threshold value (S6). The process in S6 is one example of “monitoring a load of the second process related to the first process”. To be specific, the information processing system 100 according to the embodiment 1 monitors, as indicated in S2 and S3, the load of the first process, and monitors, as indicated in S6, the load of the second process related to the first process.

Herein, the second process related to the first process connotes the second process of inputting data of a result of the second process to the first process. The first process is exemplified by the service of the graph rendering process in the embodiment 1. The second process is exemplified by the service of the graphical data generation process in the embodiment 1. Supposing that the first process is scaled out corresponding to the load of the first process, such a possibility exists that the second process of inputting the data of the result to the first process will successively be scaled out. The service concerned can be therefore scaled out quickly with the futility lessened by confirming in S6 that the load of the service concerned exceeds the threshold value after ascertaining in S2 and S3 that there is the pre-stage determination service satisfying the scale-out requirement.

Moreover, the second process related to the first process may connote the second process to which the data of the result of the first process is inputted. In this case, the first process is exemplified by the service of the graphical data generation process in the embodiment 1. The second process is exemplified by the service of the graph rendering process in the embodiment 1. This is because the first process is scaled out to thereby improve the performance, resulting in such a case that the second process receiving the input of the data of the result of the first process is scaled out.

When the load of the service concerned exceeds the threshold value, the information processing system 100 starts up the container image on the node into which the container image has been downloaded (S7). The process in S5 and the process in S7 are one example of “increasing a number of processing nodes to execute the second process”. The process in S7 is also one example of “starting up the transferred processing program by the processing node to be scaled out”. The process in S7 is further one example of “starting up the transferred processing program, and increasing the number of the processing nodes to execute the second process”.

Thereafter, the information processing system 100 loops back to the process in S2. Note that when the load of the service concerned does not exceed the threshold value, the information processing system 100 does not start up the container image but loops back to the process in S2. The determination (YES determination) that the load of the service concerned exceeds the threshold value, is one example that “a load of the second process fulfills a second condition”.

Whereas when determining in S3 that there is no pre-stage determination service satisfying the scale-out requirement, the information processing system 100 determines whether the load of the service concerned exceeds the threshold value (S8). In S3, the determination (NO determination in S3) that there is no pre-stage determination service satisfying the scale-out requirement, is one example of “the load of the first process does not fulfill the first condition”. The YES determination in the process of S8 is one example of “the load of the second process fulfills the second condition”. When the load of the service concerned exceeds the threshold value, the information processing system 100 determines whether the container image is downloaded (S9). When the container image is not downloaded, the information processing system 100 downloads the container image from the container image repository (S10). The process in S10 is one example of “transferring the processing program to execute the second process to the processing node to be scaled out via a network”.

The information processing system 100 further determines whether the load of the service concerned exceeds the threshold value continuously for a predetermined period of time (S11). A YES determination in S11 is one example of “a status of fulfilling the second condition continues for a specified period of time”. When the load of the service concerned exceeds the threshold value continuously for the predetermined period of time, the information processing system 100 starts up the container image on the node into which the container image has been downloaded (S7). The process in S10 and the process in S7 are one example of “increasing the number of the processing nodes to execute the second process”. The process in S7 is also one example of “starting up the transferred processing program on the processing node to be scaled out”. Thereafter, the information processing system 100 loops back to the process in S2. Note that when a period, during which the load of the service concerned exceeds the threshold value, does not continue for the predetermined period of time (NO determination in S11), the information processing system 100 does not start up the container image but loops back to the process in S2.

The service is kept in the status of preparing 2 during the execution of the processes in S4 through S6 in FIG. 9. When the NO determination is made in the process of S8, the service is in the stable status. The service is kept in the status of preparing 1 during the execution of the processes in S9 through S11. The service is kept in the fired status during the execution of the process in S7.

As discussed above, the information processing system 100 according to the embodiment 1 prepares for the scale-out of the service concerned when the pre-stage determination service, e.g., the dependentee service which becomes the providing destination of the output information from the service concerned is scaled out. In other words, the container image is downloaded into a new node in order for this new node to execute the process of the service concerned. The scale-out can be therefore completed earlier than by the processes of the comparative example 1 also when the scale-out is implemented in the chained manner with respect to the plurality of services having the dependencies.

The scale-out is implemented in the service concerned on condition that the load of the service concerned exceeds the threshold value. Hence, according to the embodiment 1, not only is predicted the increase in load of the service concerned having the dependency simply because of the pre-stage determination service being scaled out, but also the container image is started up on condition that the load of the service concerned actually exceeds the threshold value. Consequently, it is hard to implement the futile scale-out.

When the pre-stage determination service is not scaled out but when the load of the service concerned exceeds the threshold value, the embodiment 1 is configured to make the preparation for the scale-out. To be specific, the information processing system 100 allocates a new node that implements the service concerned in order for this new node to execute the process of the service concerned, and downloads the container image into the allocated node. When the load exceeds the threshold value continuously for the predetermined period of time or longer, the scale-out is implemented by starting up the container image. Accordingly, the preparation for the scale-out is made on such a first condition that the load of the service concerned exceeds the threshold value, and the actual scale-out is implemented on such a second condition that the load exceeds the threshold value continuously for the predetermined period of time or longer. It is therefore feasible to quickly implement the scale-out, based on the determination in the service concerned. The futile scale-out can be also inhibited by the process described above.

### Comparative Example 2

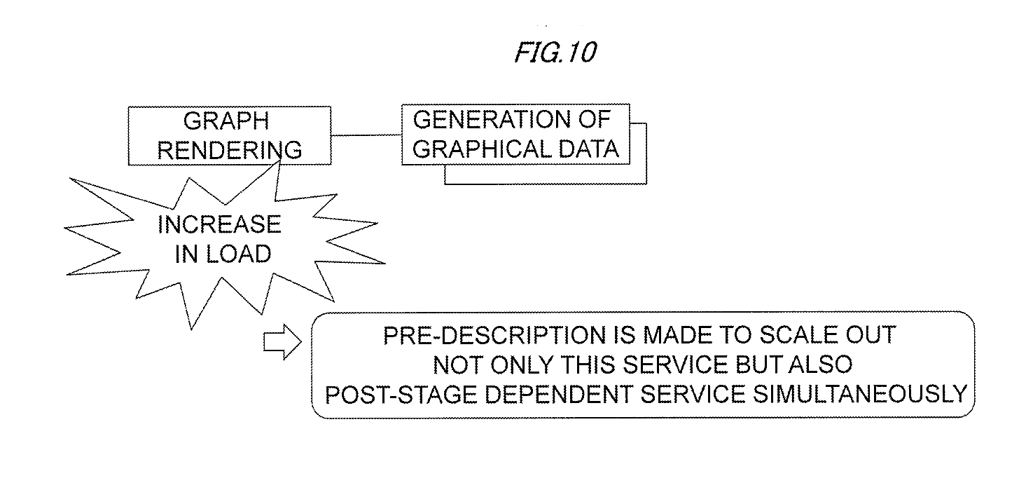

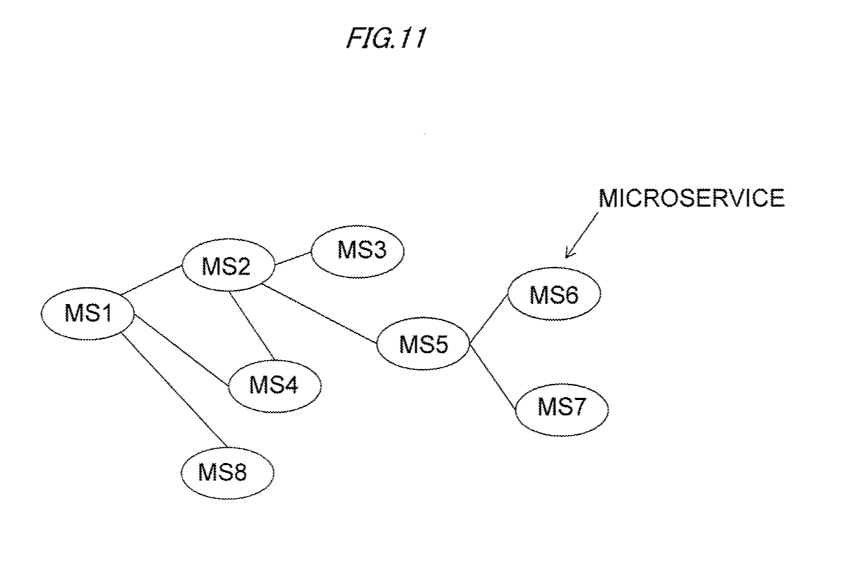

FIGS. 10 and 11 illustrate processes of a comparative example 2. FIG. 10 is a diagram illustrating the process of the scale-out in the comparative example 2. FIG. 11 is a diagram illustrating the microservices by way of one example of a processing target.

In FIG. 9, as by the process in S1, the dependence map is generated from the service definitions, the status of the service concerned is determined from the status of the pre-stage determination service and a degree of the load of the service concerned. Specifically, when the pre-stage determination service becomes the fired status, the information processing system 100 previously downloads the container image of the service concerned, and starts up the service concerned when the load of the service concerned exceeds the threshold value.

The processes in FIG. 9 are simplified into the processes in the comparative example 2 illustrated in FIG. 10. In the comparative example 2, e.g., when determining that the scale-out is implemented in the pre-stage determination service (the graph rendering process), the scale-out is implemented not only in the pre-stage determination service but also in the post-stage service concerned (the graphical data generation process). The process such as this also enables the chained scale-outs to be implemented at the earlier stage than in the comparative example 1. The processes in the comparative example 2 decrease in processing efficiency of more complicated information processing as in the case of the microservices.

The services to be assumed are the microservices having the dependencies as in FIG. 11. FIG. 11 illustrates a plurality of microservices notated by MS1 through MS8 having the dependencies. The microservices having the dependencies are mutually connected line segments. For example, let MS1 be the pre-stage determination service, and the microservices MS2, MS4 and MS8 are the dependent services having a possibility of being scaled out in the chained manner.

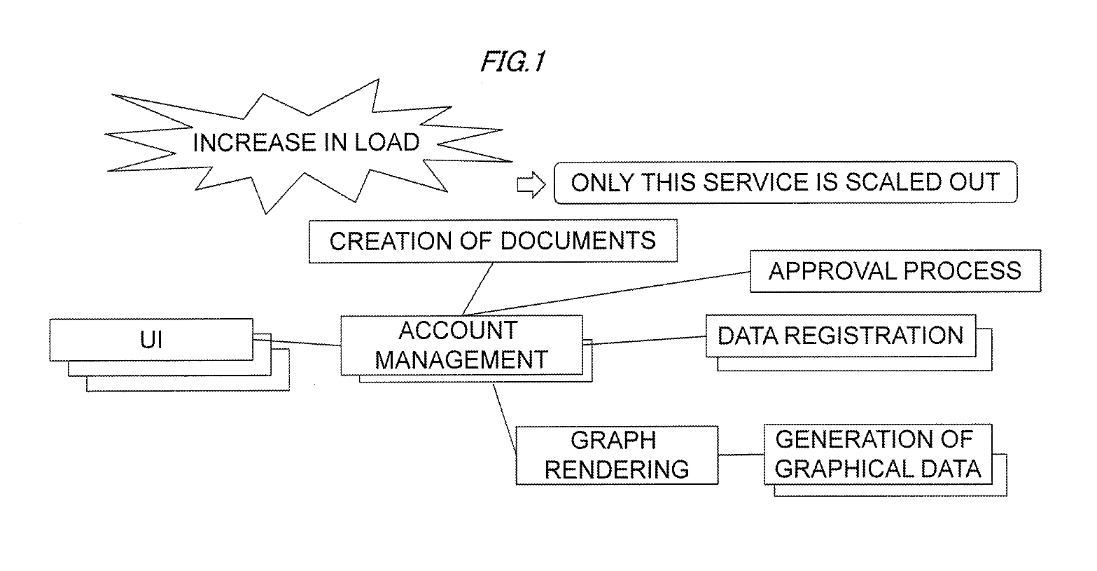

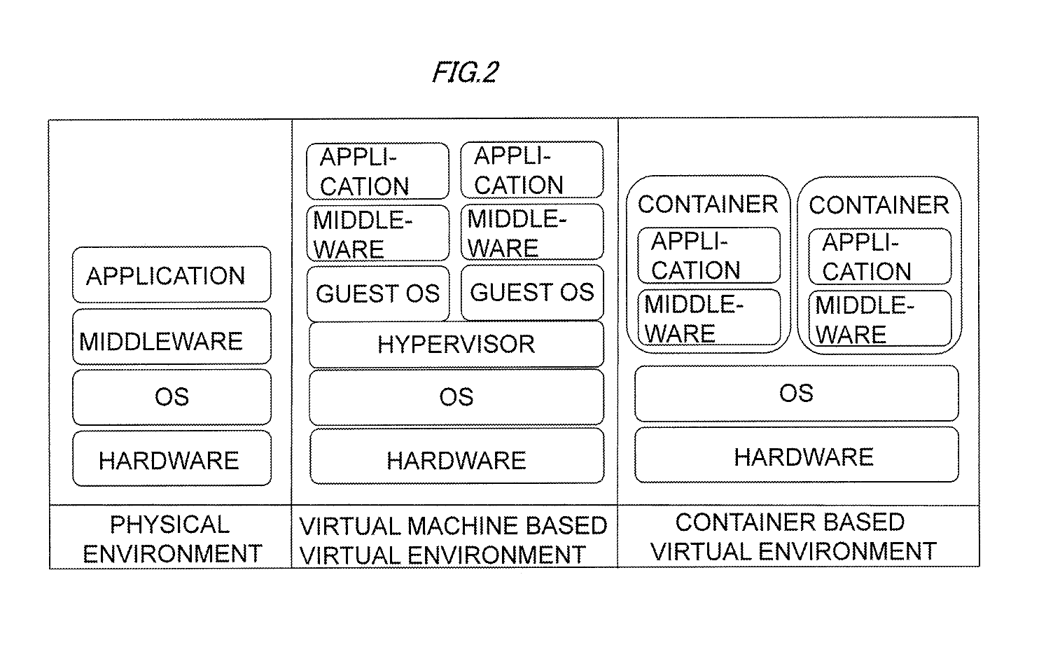

In the procedure of the comparative example 2, it follows that the user sets the scale-out conditions of all the respective services, and the dependencies between the scale-out conditions of all the respective services and the post-stage services. Actually, the dependencies may be manually defined when the dependencies are approximately three hierarchical dependencies depicted in FIG. 1 according to the comparative example 1. However, when the dependencies exist over multi-stages as in the case of the microservices and when there are many intricately related services, it is difficult to manually set the dependencies.

### Comparative Example 3

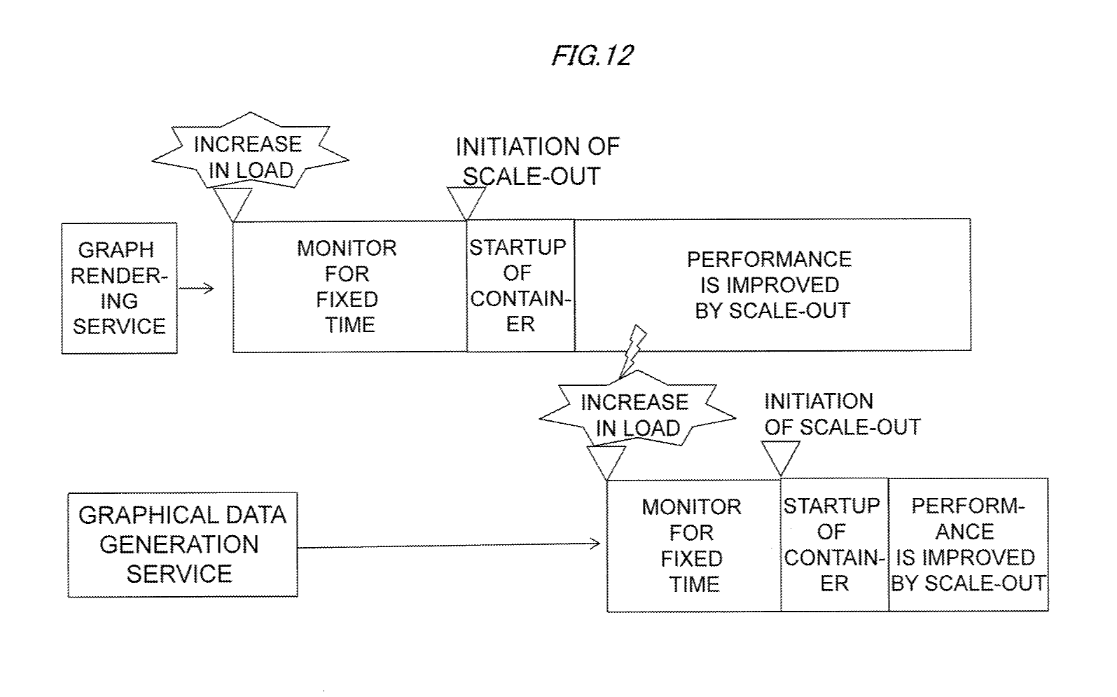

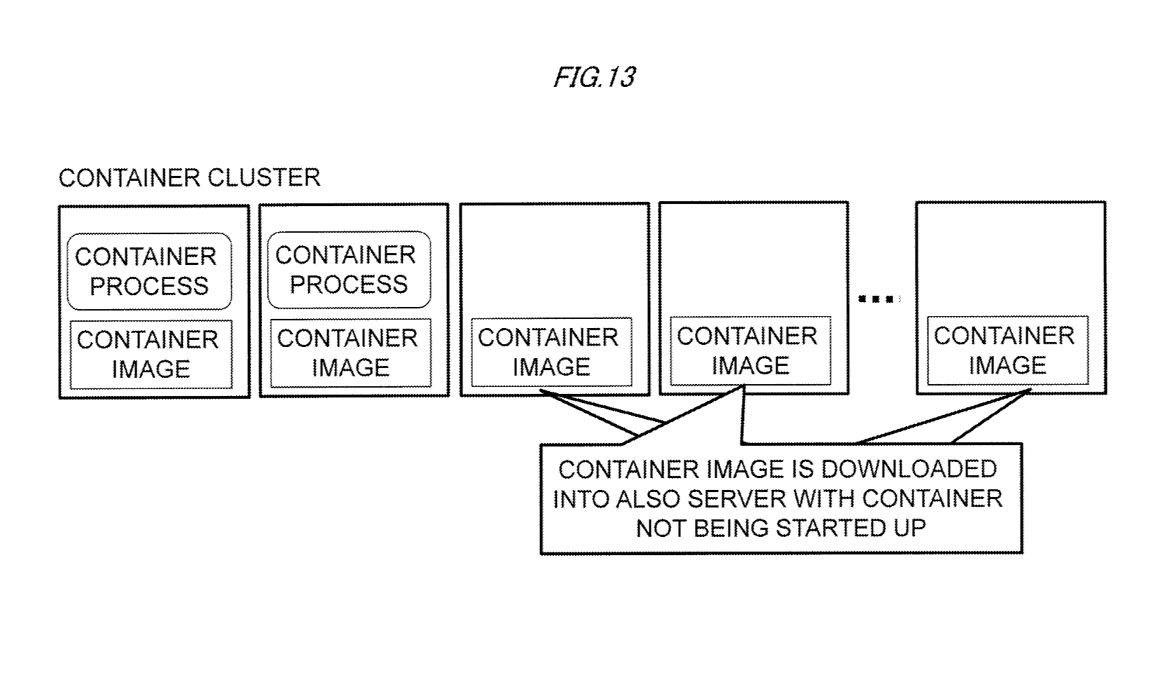

Processes of a comparative example 3 will be described with reference to FIGS. 12 and 13. In the embodiment 1, when the pre-stage determination service fulfills the scale-out condition, the container image corresponding to the post-stage service concerned is downloaded (S3-S5 in FIG. 9). Time for the scale-out can be saved by, e.g., previously downloading the container image in place of the processes of the embodiment 1 described above. However, the efficiency decreases in the case of an information processing system based on a cluster configuration.

FIG. 12 is a time chart illustrating the processes of the comparative example 3. In the processes of the comparative example 3, the container image is downloaded beforehand. It may be therefore sufficient that the information processing system starts up the downloaded container image for every service when implementing the scale-out. Consequently, time up to the completion of the scale-out gets faster than in FIG. 1 of the comparative example 1.

FIG. 13 illustrates a processing example when the information processing system previously downloads the container image according to the comparative example 3 in the information processing system based on the cluster configuration. In the information processing system based on the cluster configuration, a plurality of servers interconnected via the network provides, as the information processing system, the services. It follows in the processes of the comparative example 3 that the container image is downloaded also into the server with the container not being started up.

In other words, as in the comparative example 3, even the method of previously downloading the container image has few problems in the case of the information processing system configured to operate all the containers on one single server. In a clustered container operating environment, however, it follows that the container images are downloaded into all the nodes, resulting in large futility of resources. The embodiment 1 is speculative but small in risk for the reason that the container image of the post-stage service concerned is downloaded when the pre-stage determination service fulfills the scale-out condition. The risk against CPU resources, though causing the futility due to downloading, decreases because of not starting up the container image as far as the load of the service concerned does not actually exceed the threshold value.

### Comparative Example 4

It is determined according to the embodiment 1 whether the service concerned is required to be scaled out, depending on the status of the pre-stage determination service and a degree of the load of the service concerned (S3, S6 in FIG. 9). As a substitute for this process, however, it is also considered to determine whether the service concerned is required to be scaled out by estimating the load of the post-stage service concerned from the status of the pre-stage determination service. It is further considered to obtain an optimal scale count of the whole while progressing the determination described above in the chained manner and to simultaneously implement scaling on the whole.

The determination of the scale-out by this method is, however, no more than a prediction based on the status of the pre-stage determination service. In addition, a chained repetition of the scale-outs based on only such predictions will probably escalate errors. On this occasion, such a possibility exists that the unnecessary scale-out will be implemented. To be specific, upon an occurrence of the unnecessary scale-out in one service, the unnecessary scale-out propagates to the services related to this one service, with the result that the resources are wasted. While on the other hand, conversely an unnecessary scale-in is implemented in this one service, in which case the load applied to the service rapidly rises, and a quality of service can decline. For example, in FIG. 11, when an erroneous determination of the scale-out is made in transition from the status of the service MS1 to the service MS2, a result of the determination in the service MS2 propagates to the MS3, the MS4, and the MS5 and further to the MS7 therefrom.

On the other hand, the processing in the embodiment 1 is different from a processing method of the comparative example 4 described above in terms of points given below. A first point is that on the occasion of the service being scaled out, a processing step of downloading the container image is separated from a processing step of starting up the container. Another point is that the load of the service concerned is predicted to be high corresponding to a state of the pre-stage determination service, and the container image is downloaded. A further point is that the downloaded container image is started up corresponding to whether the actual load of the service concerned exceeds the threshold value.

With these differences between the processing methods, even supposing that the load of the service concerned is incorrectly predicted based on the load of the pre-stage determination service, the resource to be unnecessarily consumed is a just disk for downloading. Accordingly, a CPU and a memory are not consumed, and hence the system is affected to a small degree by the case that the load of the service concerned is incorrectly predicted based on the load of the pre-stage determination service. In the procedure according to the embodiment 1, when the correct prediction is made and when implementing the scale-out, the container is started up fast because of the container image being already downloaded, and it is feasible to early cope with the increase in load. The information processing system 100 according to the embodiment 1 acquires the effect in reducing the time till reaching sound statuses from high-load statuses of the plurality of services having the dependencies on each other.

### Embodiment 2

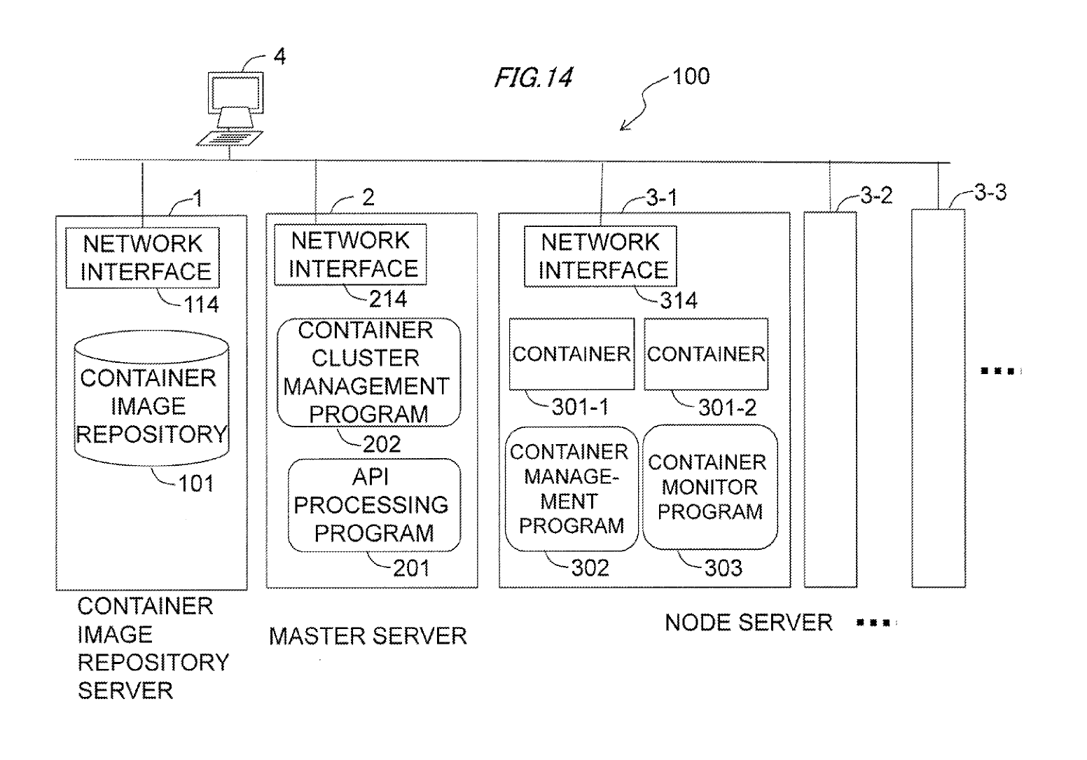

The information processing system 100 according to an embodiment 2 will be described with reference to FIGS. 14 through 19. The embodiment 1 has described the information processing system 100 configured to implement the scale-outs of the plurality of services having the dependencies faster while restraining the futility than hitherto implemented. An embodiment 2 will exemplify a procedure of implementing the same scale-out as in the embodiment 1 in the information processing system 100 including a plurality of node servers. Components and an operation of the embodiment 2 are substantially the same as those of the embodiment 1 except a point that the configuration of the information processing system 100 is further materialized.

FIG. 14 is a diagram illustrating a configuration of the information processing system 100. Note that FIG. 14 depicts also a user terminal 4 that accesses the information processing system 100. As in FIG. 14, the information processing system 100 includes a container image repository server 1, the master server 2, a plurality of node servers 3-1, 3-2, 3-3, . . . . Note that the node servers 3-1, 3-2, 3-3 are, when generically termed, simply referred to as the node servers 3. An information processing apparatus 10 in FIG. 14 can be said to be an information processing system based on the cluster configuration. The information processing system 100 is one example of “a computer system”.

The container image repository server 1 includes a network interface 114 and a container image repository 101. The container image repository server 1 accesses the network via the network interface 114, and thus performs communications with the master server 2 and the node servers 3. The container image repository 101 is a certain type of database, and registers the container images. The container image repository server 1 manages the container images stored in the container image repository 101.

The master server 2 includes a network interface 214, an Application Programming Interface (API) processing program 201, and a container cluster management program 202. The master server 2 accesses the network via the network interface 214, and thus performs the communications with the container image repository server 1 and the node servers 3.

The master server 2 processes a request given from the user terminal 4 by running the API processing program 201, and hands over the request to the container cluster management program 202. The master server 2 runs the container cluster management program 202, thereby acquiring statuses of the respective node servers 3 and managing the nodes of the cluster, the services and the containers. For example, the master server 2 registers tasks in response to the user's request, based on the container cluster management program 202 and predetermined settings as well.

The node server 3 includes a network interface 314, a container management program 302, and a container monitor program 303. The node server 3 accesses the network via the network interface 314, thus performing the communications with the container image repository server 1 and the master server 2.

The node server 3 runs the container management program 302, thereby acquiring information from the master server 2 that runs the container cluster management program, downloading the container image, and starting up or deleting the container. The node server 3 monitors a resource usage quantity and other equivalent items of the container by running the container monitor program 303.

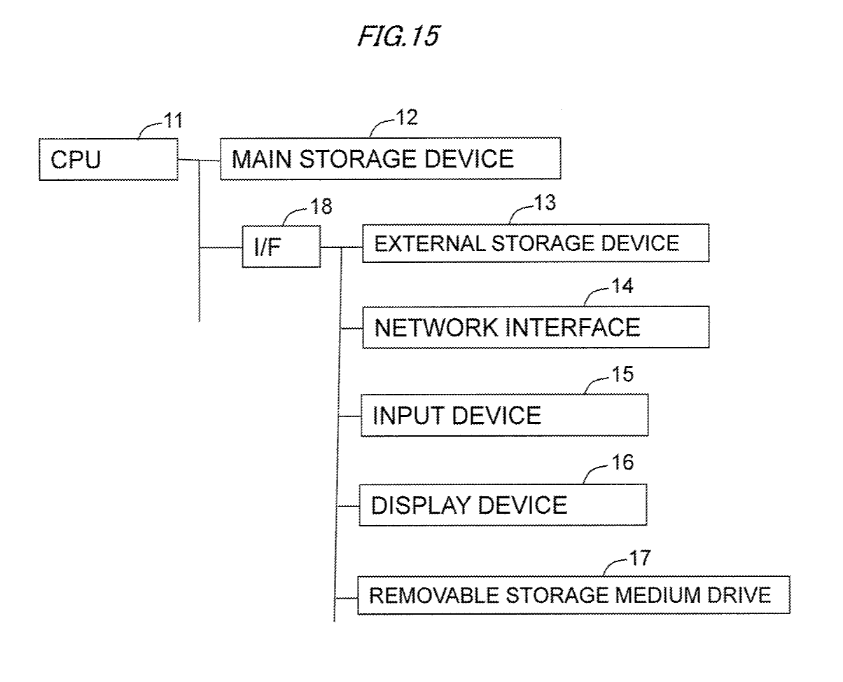

FIG. 15 illustrates a hardware configuration of the information processing apparatus 10 utilized as the container image repository server 1, the master server 2, or the node server 3. Note that the information processing apparatus 10 can be also utilized as the user terminal 4.

The information processing apparatus 10 includes a Central Processing Unit (CPU)11, a main storage device 12, and external devices connected thereto via an interface 18, and executes information processing based on a program. The external devices can be instanced by an external storage device 13 and a network interface 14. The CPU 11 executes an information processing method of the information processing apparatus 10 by running a computer program deployed in an executable manner on the main storage device 12. The CPU 11 is one example of “a processor”.

The main storage device 12 stores the computer program to be run by the CPU 11, data to be processed by the CPU 11, and other equivalent software. The main storage device 12 is instanced by a Dynamic Random Access Memory (DRAM), a Static Random Access Memory (SRAM), and a Read Only Memory (ROM). The main storage device 12 is one example of “a memory”.

The external storage device 13 stores the computer program to be used as a storage area auxiliary to the main storage device 12 and run by the CPU 11, the data to be processed by the CPU 11, and other equivalent software. The external storage device 13 is instanced by a Hard Disk Drive (HDD) and a Solid State Drive (SSD).

The information processing apparatus 10 may also be configured to include user interfaces employing an input device 15, a display device 16 and other equivalent devices. The input device 15 is instanced by a keyboard and a pointing device. The display device 16 is instanced by a Liquid Crystal Display (LCD) and an electroluminescence panel. The information processing apparatus 10 may further be provided with a removable storage medium drive 17. A removable storage medium is instanced by a Blu-ray Disc (BD), a Digital Versatile Disc (DVD), a Compact Disc (CD) and a flash memory card. Note that the single interface 18 is illustrated in the example of FIG. 15; and, however, a plurality of interfaces of plural types may also be provided as the interfaces 18.

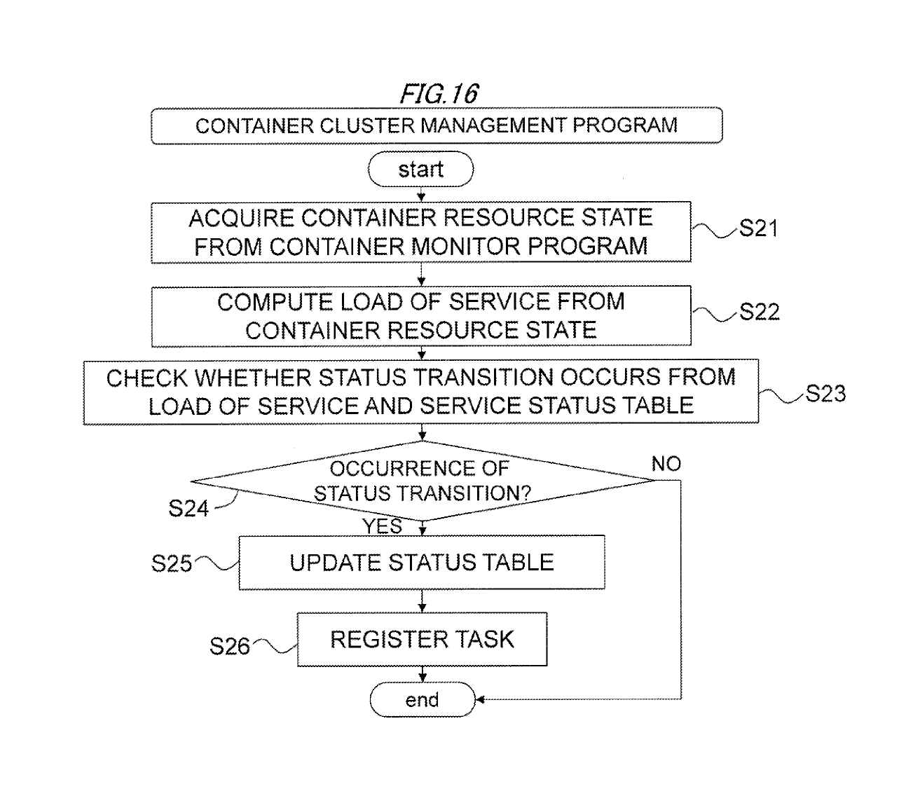

FIG. 16 illustrates processes of the container cluster management program 202. The CPU 11 of the master server 2 executes the processes in FIG. 16 in accordance with the container cluster management program 202 deployed in the executable manner on the main storage device 12. The master server 2 is one example of “a management node”.

The master server 2 acquires a resource state of the container from the node server 3 that runs the container monitor program 303 (S21). The master server 2 computes a resource state of the server from the acquired resource state of the container (S22). The master server 2 subsequently checks, based on the resource state of the service and a service status table, whether a status transition occurs (S23). The service status table is saved in the main storage device 12 of the master server 2. The service status table retains the statuses of the respective services. The check in S23 is, e.g., a check about whether the load of the service in the stable status exceeds the threshold value. The check in S23 also involves checking whether the status of preparing 1 continues for the predetermined period of time. The check in S23 further involves checking whether the pre-stage determination service of the service reaches the fired status while the service is in the stable status. The check in S23 still further involves checking whether the load of the service in the status of preparing 2 exceeds the threshold value. When affirmative determinations about these checks are made, the master server 2 determines that the status transition occurs.

When determining that the status transition occurs (YES determination in S24), the master server 2 updates the status table (S25). The master server 2 registers the tasks (S26). For example, the “task” is herein defined as downloading the container image and starting up the downloaded container image.

The processes in S21 through S23 are one example of “monitoring a load of a first process”. The processes in S21 through S23 are also one example of “monitoring a load of a second process”. For example, an event that the pre-stage determination service reaches the fired status is one example that “the load of the first process fulfills a first condition”. An event that the load exceeds the threshold value in the service in the status of preparing 2 is one example that “the load of the second process fulfills a second condition”. The check about whether the load exceeds the threshold value in the service in the stable status is one example that “the load of the second process fulfills the second condition when the load of the first process does not fulfill the first condition”. An event that the status of preparing 1 continues for the predetermined period of time is one example that a status of fulfilling the second condition continues for a specified period of time”.

One example of the case that status transition occurs in the process of S23 corresponds to a case in which the status transitions to “preparing 1” from “Stable”. When the status transitions to “preparing 1”, the task of downloading the container image is registered in the process of S26. Another example of the case that the status transition occurs corresponds to a case in which the status transitions to “fired” from “preparing 1”. When the status transitions to “fired”, the task of starting up the container is registered in the process of S26. An event that the task of starting up the container is registered in the process of S26 is one example of “increasing a number of processing nodes to execute the second process”.

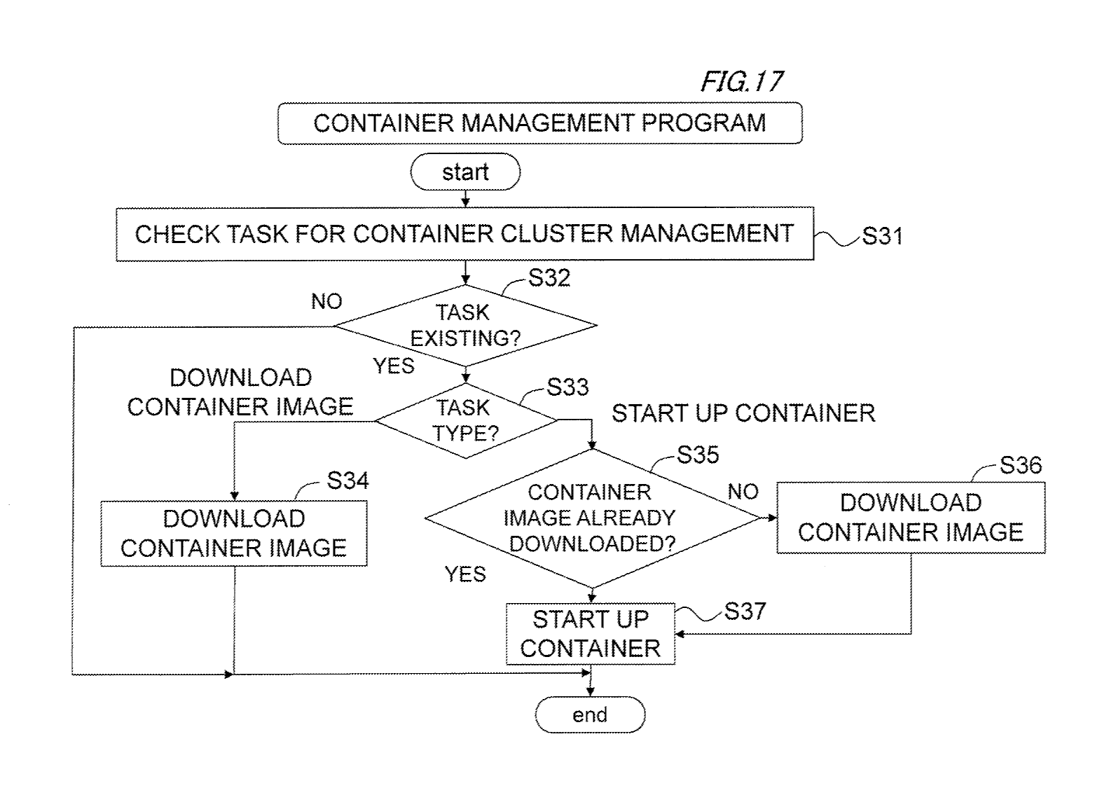

FIG. 17 illustrates processes of the container management program 302. The CPU 11 of the node server 3 executes the processes in FIG. 17, based on the container management program 302 deployed in the executable manner on the main storage device 12. The node server 3 is one example of “a processing node”.

The node server 3 checks whether any task is registered in the master server 2 that runs the container management program (S31). When the task is registered in the master server 2 (YES in S32), the node server 3 determines a type of the task (S33). The task is categorized as downloading the container image, in which case the node server 3 downloads the container image from the container image repository 101 (S34). The process in S34 is one example of “transferring a processing program to execute a second process related to the first process to the processing node to be scaled out for executing the second process via a network”.

On the other hand, when the task is categorized as starting up the container, the node server 3 determines whether the container image is already downloaded (S35). Whereas when the container image is not yet downloaded, the node server 3 downloads the container image (S36). The node server 3 starts up the downloaded container image (S37). The process in S37 is one example of “starting up the transferred processing program on the processing node to be scaled out”.

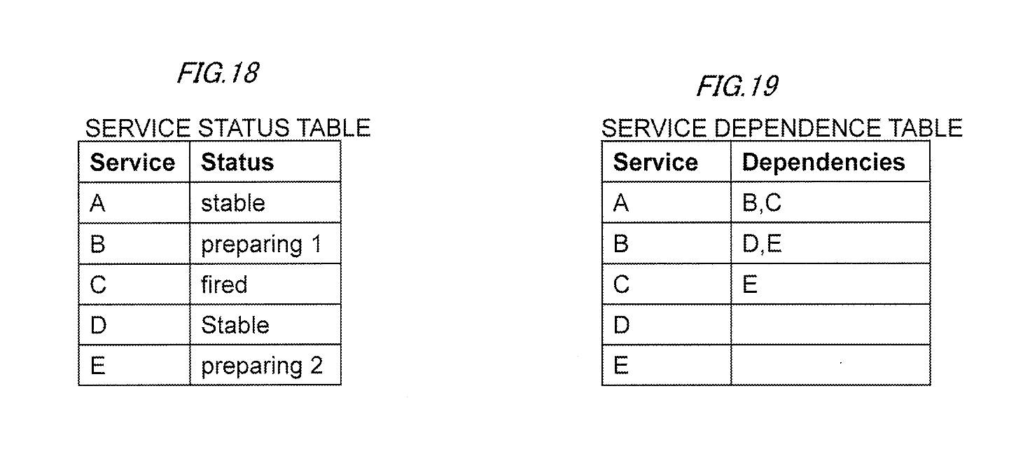

FIG. 18 illustrates a structure of a service status table. The service status table retains the states of the respective services at the present time. In an example of FIG. 18, the service status table retains “stable”, “preparing 1”, “fired”, “stable” and “preparing 2” as the statuses (given in a “Status” field) of services A, B, C, D and E. With the status transition, the service status table is updated by the process in S25 of FIG. 16.

FIG. 19 illustrates a structure of a service dependence table. The service dependence table defines the dependencies among the services. In an example of FIG. 19, the dependencies are defined such that the service A depends on the services B and C; the service B depends on the services D and E; and the service C depends on the service E. A relationship of dependency that, e.g., the service A depends on the service B represents such a relationship that the service A is provided with the data from the service B. For example, the service of the graph rendering process in the embodiment 1 can be said to depend on the graphical data generation service. Conversely, however, the relationship that the service A depends on the service B may also be defined as a relationship that the service A provides the service B with the data. For instance, the graphical data generation service may also be set to depend on the service of the graph rendering process.

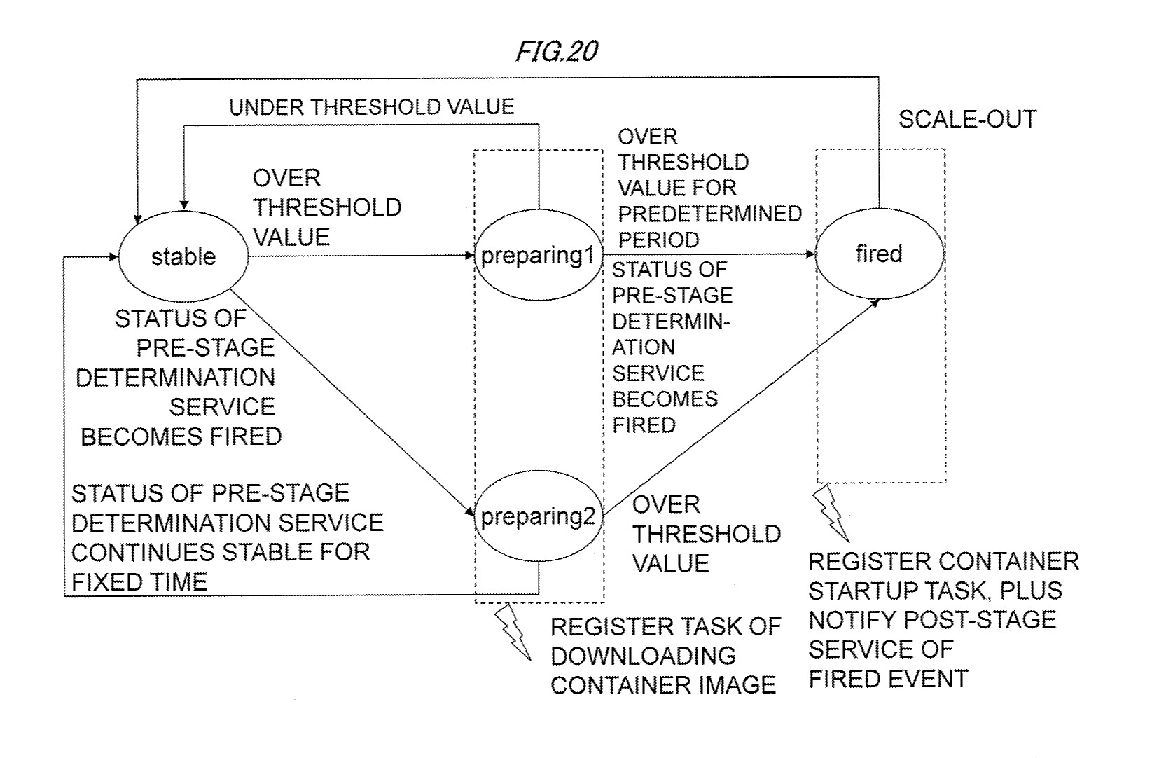

FIG. 20 depicts the status transition of one service. For example, an assumption is that a certain single service is currently in the stable status. When then load of the service in the stable status exceeds the threshold value, this service transitions to the status of preparing 1. When the status of the service becomes preparing 1, as described in the process of S26 in FIG. 16, the task of downloading the container image is registered, and the container image is downloaded beforehand in the process of S34 in FIG. 17. When the load of the service decreases under the threshold value before the load of the service transitioning to the status of preparing 1 continues for the predetermined period of time, this service returns again to the stable status.

On the other hand, when the load of the service transitioning to the status of preparing1 continues for the predetermined period of time, the status becomes “fired”. Upon the service status becoming “fired”, as described in S26 of FIG. 16, the task of starting up the container is registered, and the container image is started up in the process of S37 of FIG. 17. Note that the status of the service concerned becomes “fired” also when one service is in the status of preparing 1 and when the pre-stage determination service comes to the fired status.

When the status of the pre-stage determination service becomes “fired” with respect to the service in the stable status, the service in the stable status transitions to the status of preparing 2. Upon the service becoming the status of preparing 2, as described in the process of S26 of FIG. 16, the task of downloading the container image is registered, and the container image is downloaded beforehand in the process of S34 of FIG. 17. When the load of the service in the status of preparing 2 exceeds the threshold value, the status of the service becomes “fired”. When the status of the service becomes “fired”, the task of starting up the container is registered in the same way as the transition to “fired” from “preparing 1” described above, and the container image is started up in the process of S37 of FIG. 17.

### Effect of Embodiment

As described above, in the information processing system according to the embodiment 2, the master server 2 acquires the resource state of the container from the node server 3 that runs the container monitor program 303 (S21 in FIG. 16), and computes the load of the service from the resource state (S22 in FIG. 16). The master server 2 determines whether the status transition occurs, based on the load of the service and the service status table (S23, S24 in FIG. 16). For example, when the load of the service in the stable status exceeds the threshold value, the status transitions to “preparing 1” from “stable”. When the the status of the pre-stage determination service becomes “fired” with respect to the service in the stable status, the service in the stable status transitions to the status of preparing 2. When the status of the service transitions to “preparing 1” or “preparing 2”, the master server 2 registers the task assigned to the node server 3 so as to download the container image for starting up this service (S26 in FIG. 16). The node server 3 executes the registered task of downloading the container image, thereby downloading the container image to be started up for the scale-out beforehand.

When the status of preparing 1 continues for the predetermined period of time, the status of the service transitions to “fired”. When the load of the service in the status of preparing 2 exceeds the threshold value, the status transitions to “fired”. When the status of the service transitions to “fired”, the master server 2 registers the task assigned to the node server 3 so as to start up the container image corresponding to this service (S26 in FIG. 16). The node server 3 starts up the container image, based on the registered task (S37 in FIG. 17).

Thus, the information processing system 100 in the embodiment 2 monitors the load of the second process related to the first process in the same way as in the embodiment 1. Herein, the second process related to the first process connotes a second process of inputting data of a result of the second process to the first process. The first process is exemplified by the service of the graph rendering process in the embodiment 1. The second process is exemplified by the service of the graphical data generation process in the embodiment 1. The second process related to the first process also connotes a second process receiving an input of a result of the first process. In this case, the first process is exemplified by the service of the graphical data generation process in the embodiment 1. The second process is exemplified by the service of the graph rendering process in the embodiment 1.

When the status of the pre-stage determination service corresponding to the first process fulfills the first condition being “fired” and when the load on executing the second process exceeds the threshold value, the node server 3 starts up the container image, thereby implementing the scale-out. To be specific, the information processing system 100 according to the embodiment 2 also implements the prediction from the status of the pre-stage determination service and the scale-out depending on the state of the actual load of the service concerned in the same way as in the embodiment 1. The processes described above enable the information processing system 100 according to the embodiment 2 to implement the scale-out with less futility and faster than in the comparative examples 1 through 4.

Similarly to the embodiment 1, the information processing system 100 according to the embodiment 2, at first, downloads the container image, based on the prediction based on information that the status of the pre-stage determination service becomes “fired”. The information processing system 100 starts up the downloaded container image, depending on the state of the actual load of the service concerned. Accordingly, the scale-out is implemented by being separated into the step of downloading the container and the step of starting up the container image when implementing the scale-out in a way that the node server 3 runs the container image. The processes described above enable the information processing system 100 according to the embodiment 2 to implement the scale-out with less futility and faster than in the comparative examples 1 through 4.

In the information processing system 100 according to the embodiment 2, the status becomes “preparing 1” not even when the status of the pre-stage determination service becomes “fired” but when the load of the service concerned exceeds the threshold value. Consequently, the container image is downloaded into the node server 3. When the status of preparing 1 continues for the predetermined period of time, the node server 3 starts up the container image. The information processing system 100 according to the embodiment 2 therefore determines whether the scale-out is required to be implemented at the 2 stages by monitoring the service concerned, not depending on the status of the pre-stage determination service. In this case also, the scale-out is implemented at the 2 stages of downloading the container image and the starting up the container image. Accordingly, the processes described above also enable the information processing system 100 according to the embodiment 2 to implement the scale-out with less futility and faster than in the comparative examples 1 through 4.

Thus, the scale-out is implemented by being separated into the step of downloading the container and the step of starting up the container image also when determining whether the scale-out is required to be implemented at the 2 stages by monitoring the service concerned, not depending on the status of the pre-stage determination service. The processes described above further enable the information processing system 100 according to the embodiment 2 to implement the scale-out with less futility and faster than in the comparative examples 1 through 4.

The implementation of the scale-out based on a virtual machine has hitherto required a considerable length of time for starting up the virtual machine. For example, in a cloud computing service “Infrastructure as a Service (IaaS)”, the scale-out involves spending the time on a minute basis, and therefore has a small degree of relative influence even by reducing the time other than generating an instance and starting up, resulting in disability of acquiring an effect. Herein, the “instance” is defined as the virtual machine provided in the IaaS. The IaaS is defined as a service enabling an infrastructure instanced by equipments and lines needed for operating the information system to be used remotely on the Internet. On the other hand, the time till the startup in the case of implementing the scale-out on a container basis is reduced to a greater degree by two digits than based on the virtual machine in the case of implementing the scale-out on a virtual machine basis.

Therefore, in the case of implementing the scale-out on the container basis, it follows that the time for downloading other than starting up has remarkable influence on the time for the scale-out. In the processes of the embodiment 1 and 2, when the pre-stage determination service becomes the fired status with respect to one service, the container image for implementing this single service concerned is downloaded into the node server 3. When the load of the single service concerned exceeds the threshold value, the container image corresponding to the service concerned is started up by the node server 3 into which the container image is downloaded. In the processes of the embodiment 2, it is therefore feasible to reduce the influence of the time for the download other than the startup on the time for the scale-out.

<Computer Readable Non-Transitory Recording Medium>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a ROM (Read-Only Memory) and other equivalent recording mediums are given as the non-transitory recording mediums fixed within the computer and other equivalent apparatuses. Further, a Solid State Drive (SSD) is also available as the non-transitory recording medium removable from the computer and other equivalent apparatuses and also as the non-transitory recording medium fixed within the computer and other equivalent apparatuses.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such example in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A computer readable non-transitory recording medium storing a computer program to make a computer system enabled to change a number of processing nodes to execute a plurality of processes by distributing loads, the computer program configured to make the computer system execute:
monitoring a load of a first process; and
transferring a processing program to execute a second process related to the first process to a processing node to be scaled out to execute the second process via a network when the load of the first process fulfills a first condition.

2. The computer readable non-transitory recording medium storing the computer program according to claim 1, further making the computer system execute starting up the transferred processing program, and increasing the number of processing nodes to execute the second process when a load of the second process fulfills a second condition.

3. The computer readable non-transitory recording medium storing the computer program according to claim 1, further making the computer system execute increasing the number of processing nodes to execute the second process when the load of the first process does not fulfill the first condition, when a load of the second process fulfills the second condition and when a status of fulfilling the second condition continues for a specified period of time.

4. The computer readable non-transitory recording medium storing the computer program according to claim 3, wherein the increasing the number of processing nodes includes transferring the processing program to execute the second process to the processing node to be scaled out when the load of the second process fulfills the second condition, and starting up the transferred processing program on the processing node to be scaled out when the status of fulfilling the second condition continues for the specified period of time.

5. An information processing method by which a computer system enabled to change a number of processing nodes to execute a plurality of processes by distributing loads, the information processing method comprising:
monitoring a load of a first process; and
transferring a processing program for executing a second process related to the first process to a processing node to be scaled out to execute the second process via a network when the load of the first process fulfills a first condition.

6. A management node to manage a computer system enabled to change a number of processing nodes to execute a plurality of processes by distributing loads, the management node comprising a processor and a memory to store a computer program, the computer program making the processor execute:
monitoring a load of a first process; and
transferring a processing program to execute a second process related to the first process to a processing node to be scaled out to execute the second process via a network when the load of the first process fulfills a first condition.

7. An information processing system enabled to change a number of processing nodes to execute a plurality of processes by distributing loads, comprising:
the processing nodes; and
a management node to manage the processing nodes,
the management node including:
a processor; and
a memory to store a computer program,
the computer program making the processor execute:
monitoring a load of a first process; and
transferring a processing program to execute a second process related to the first process to a processing node to be scaled out to execute the second process via a network when the load of the first process fulfills a first condition.
